(19) United States
(12) Patent Application Publication
(10) Pub. No.: US 2025/0166163 A1
(43) Pub. Date: May 22, 2025

(54) INFORMATION PROCESSING SYSTEM, INFORMATION PROCESSING APPARATUS, AND MACHINE LEARNING METHOD

(71) Applicant: CANON KABUSHIKI KAISHA, Tokyo (JP)

(72) Inventor: KEIJI WATANABE, Kanagawa (JP)

(21) Appl. No.: 18/949,114

(22) Filed: Nov. 15, 2024

(30) Foreign Application Priority Data
Nov. 22, 2023 (JP) 2023-198154

(51) Int. Cl. G06T 7/00; G06T 7/194; H04N 23/11

(52) U.S. Cl. CPC G06T 7/0008; G06T 7/194; H04N 23/11; G06T 2207/20081; G06T 2207/30148

(57) ABSTRACT

Provided is an information processing system, including: a division unit configured to divide a captured image; a correction equation creation unit configured to create a correction equation for each divided region of the divided captured image based on a feature amount expressing an image of the divided region; an inference image creation unit configured to create an inference image expressed by the feature amount for each divided region according to the correction equation for each divided region; and a learning unit configured to execute machine learning on a learning model in which the inference image is used as training data, and the captured image is used as input data.

### BACKGROUND OF THE INVENTION

### Field of the Invention

The present disclosure relates to an information processing system, an information processing apparatus, and a machine learning method and specifically relates to a machine learning technique in an information processing system that performs inspection based on an image.

### Description of the Related Art

In a system that inspects a defect and the like of an inspection target based on an image, for example, in machine learning of image recognition, a classified image is learned as training data. Additionally, the classification is performed based on a feature that is extracted from the image. In addition, an inspection system that is learned by repeating learning so as to minimize an error on a training image close to zero is generated, and the classification accuracy in the inspection is enhanced. Regarding this training image, Japanese Patent Laid-Open No. 2014-178229 (referred to as PTL 1) describes that a point corresponding to a position within a predetermined distance from a point occupied by a training image, which is obtained from an actual image with a defect in a feature amount space formed of multiple types of feature amounts, is created as a pseudo (secondary) training image. That is, the number of the training data in the machine learning is increased by secondarily creating an image with a defect as the training image.

However, depending on the image actually obtained, for example, brightness and contrast may be different between regions in the image. In this case, in PTL 1, an obtained feature amount does not reflect accurately the brightness and the contrast of each region. As a result, there is a possibility that the training image generated secondarily has low expression accuracy.

### SUMMARY OF THE INVENTION

The present disclosure is an information processing system, including: a division unit configured to divide a captured image; a correction equation creation unit configured to create a correction equation for each divided region of the divided captured image based on a feature amount expressing an image of the divided region; an inference image creation unit configured to create an inference image expressed by the feature amount for each divided region according to the correction equation for each divided region; and a learning unit configured to execute machine learning on a learning model in which the inference image is used as training data, and the captured image is used as input data.

Further features of the present invention will become apparent from the following description of exemplary embodiments with reference to the attached drawings.

### BRIEF DESCRIPTION OF THE DRAWINGS

FIG. 1 is a diagram illustrating a configuration of a processing system;

FIG. 2 is a block diagram illustrating a configuration of a cloud server and an edge server;

FIG. 3 is an exterior view of a smartphone;

FIGS. 4A and 4B are diagrams illustrating a printer;

FIG. 5 is a block diagram illustrating a configuration of the smartphone illustrated in FIG. 3;

FIG. 6 is a block diagram illustrating a configuration of the printer illustrated in FIG. 4;

FIG. 7 is a diagram illustrating a software configuration of a processing system;

FIGS. 8A and 8B are conceptual views illustrating a structure of inputting and outputting in a case of using a learning model and a learned model;

FIG. 9 is a flowchart illustrating learning processing according to a first embodiment of the present disclosure;

FIG. 10 is a diagram illustrating a captured image;

FIG. 11 is a diagram illustrating the captured image divided into regions in the first embodiment of the present disclosure;

FIGS. 12A and 12B are diagrams describing correction of brightness and contrast;

FIG. 13 is a diagram illustrating an inference image in which the brightness is corrected;

FIG. 14 is a diagram illustrating the inference image in which the contrast is corrected;

FIGS. 15A and 15B are diagrams illustrating an inference flow of the first embodiment of the present disclosure;

FIG. 16 is a diagram illustrating a learning flow of a second embodiment of the present disclosure;

FIG. 17 is a diagram illustrating a combination of the inference images divided into regions in the second embodiment of the present disclosure;

FIG. 18 is a diagram illustrating an inference flow of the second embodiment of the present disclosure;

FIG. 19 is a diagram illustrating the captured image divided into regions in a third embodiment of the present disclosure; and

FIG. 20 is a diagram illustrating a combination of the inference images divided into regions in the third embodiment of the present disclosure.

### DESCRIPTION OF THE EMBODIMENTS

Embodiments of the present disclosure are described below in detail. Note that, constituents described in the embodiments indicate a mode as an example of the present disclosure and are not intended to limit the scope of disclosure thereto.

### First Embodiment

### (Configuration of Processing System)

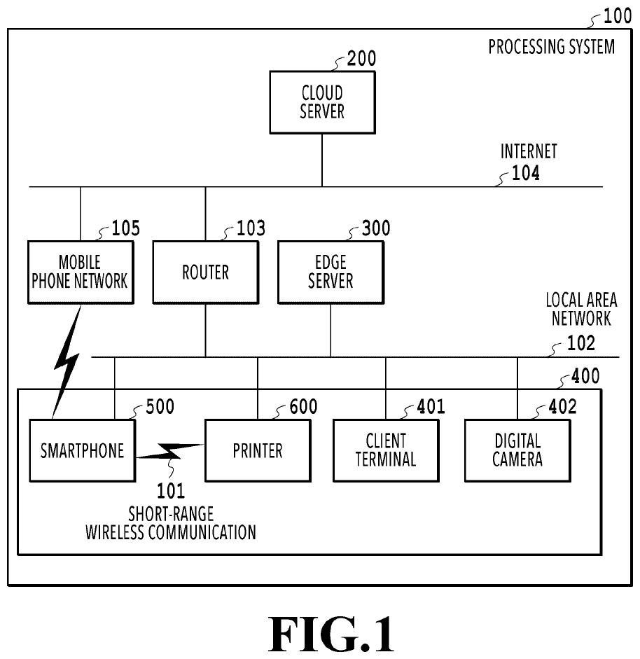

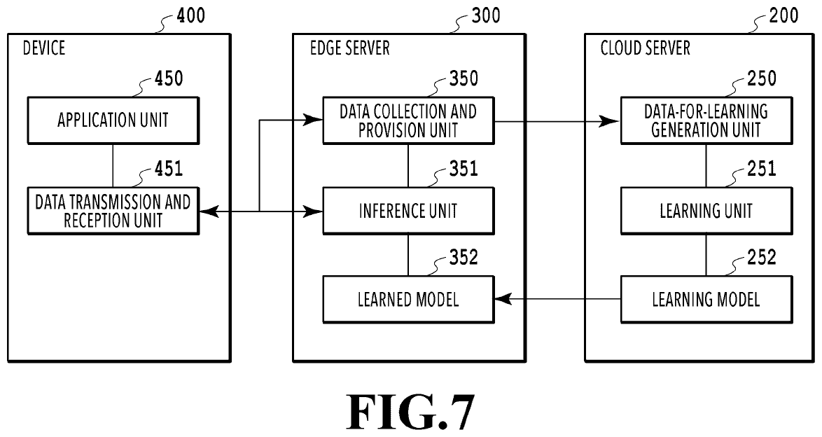

FIG. 1 is a diagram illustrating a configuration of a processing system 100 that is an embodiment of the present disclosure. The present processing system 100 includes a cloud server 200, an edge server 300, and a device 400 connected to each other by a local area network 102 and the Internet 104. As described later in FIG. 7 and the like, the cloud server 200 has a configuration related to machine learning, and additionally, likewise, as described later in FIG. 7 and the like, the edge server 300 has a configuration related to inference by a learned model. That is, the processing system 100 of the present embodiment functions as an information processing system that executes the machine learning related to substrate inspection based on a captured image of a substrate and performs inference related to the inspection by the learned model by the machine learning. Additionally, as described above, the cloud server 200 functions as an information processing apparatus that generates training data (a training image) and executes the learning by using the generated training data.

The device 400 includes various devices that can be connected by a network. For example, the various devices include a smartphone 500, a printer 600, a client terminal 401 such as a personal computer and a workstation, and a digital camera 402. The device 400 is not limited to these types and may be, for example, home electronics such as a refrigerator, a television, and an air conditioner. These devices 400 are connected to each other by the local area network 102 and can be connected with the Internet 104 via a router 103 disposed on the local area network 102. In this case, the router 103 is illustrated as an instrument that connects the local area network 102 and the Internet 104; however, the router 103 may have a wireless LAN access point function forming the local area network 102. In this case, in addition to the connection with the router 103 by the wired LAN, each device 400 may be formed so as to be able to access the local area network 102 by connection by a wireless LAN. For example, the printer 600 and the client terminal 401 may be formed to be connected by the wired LAN, and the smartphone 500 and the digital camera 402 may be formed to connected by the wireless LAN. Each device 400 and the edge server 300 can communicate mutually with the cloud server 200 through the Internet 104 connected via the router 103.

The edge server 300 and each device 400 can communicate with each other through the local area network 102. Additionally, the each devices 400 can also communicate with each other through the local area network 102. Moreover, the smartphone 500 and the printer 600 can communicate with each other by short-range wireless communication 101. As the short-range wireless communication 101, wireless communication in compliance with Bluetooth (registered trademark) standards and NFC standards may be used. Furthermore, the smartphone 500 is also connected with a mobile phone network 105 and can communicate with the cloud server 200 via this mobile phone network 105.

Note that, this system configuration shows an example of the present disclosure and may have a different configuration. For example, although an example in which the router 103 has the access point function is shown, the access point may be formed by a device different from the router 103. Additionally, a connection unit other than the local area network 102 may be used for the connection between the edge server 300 and each device 400. For example, wireless communication such as LPWA, ZigBee, Bluetooth (registered trademark), and short-range wireless communication other than the wireless LAN, wired connection such as a USB, infrared communication, and the like may be used. (Server)

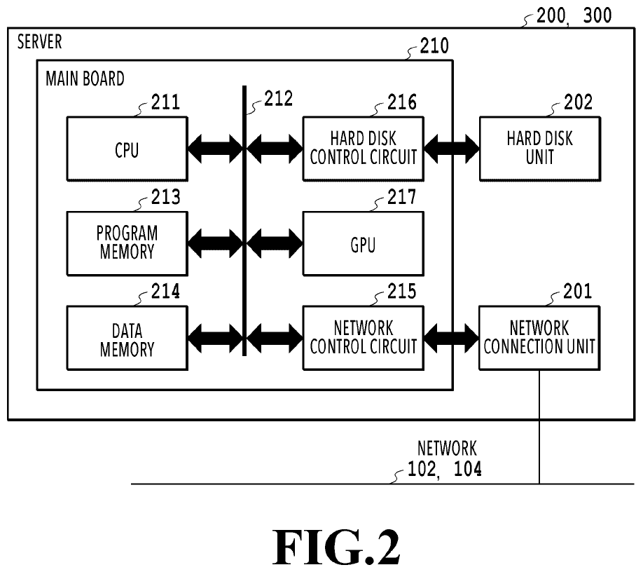

FIG. 2 is a block diagram illustrating a configuration of the cloud server 200 and the edge server 300. In this case, it is described that a common hardware configuration is used for the cloud server 200 and the edge server 300. The servers 200 and 300 include a main board 210 that controls overall the apparatus, a network connection unit 201, and a hard disk unit 202.

On the main board 210, a CPU 211, a program memory 213, a data memory 214, a hard disk control circuit 216, a GPU 217, and a network control circuit 215 are arranged. The CPU 211 in the form of a microprocessor operates according to a control program stored in the program memory 213 connected via an internal bus 212 and contents of the data memory 214. The CPU 211 is connected with a network such as the Internet and the local area network 102 by controlling the network connection unit 201 via the network control circuit 215 and establishes communication with another device. The CPU 211 reads and writes data from and to the hard disk unit 202 connected through the hard disk control circuit 216.

The hard disk unit 202 stores an operating system loaded in the program memory 213 to be used, control software of the servers 200 and 300, and also various data.

The GPU 217 is connected to the main board 210, and it is possible to execute various types of computation processing instead of the CPU 211. The GPU 217 can perform efficient computation by parallel processing of more data; for this reason, it is effective to perform processing by the GPU 217 in a case of performing the learning multiple times by using a learning model such as deep learning. Therefore, in the present embodiment, the GPU 217 is used in addition to the CPU 211 for processing by a learning unit 251, which id described later. Specifically, in a case where a learning program including the learning model is executed, the learning is performed by computation by the CPU 211 and the GPU 217 in cooperation with each other. Note that, in the processing of the learning unit 251, the computation may be performed by only the CPU 211 or the GPU 217. Additionally, an inference unit 351 described later may also use the GPU 217 as with the learning unit 251.

Additionally, although it is described in the present embodiment that the common configuration is used for the cloud server 200 and the edge server 300, the present disclosure is not limited to this configuration. For example, a configuration in which the GPU 217 is arranged on the cloud server 200 but not on the edge server 300 or a configuration using the GPU 217 of different performance may be applied.

### (Smartphone)

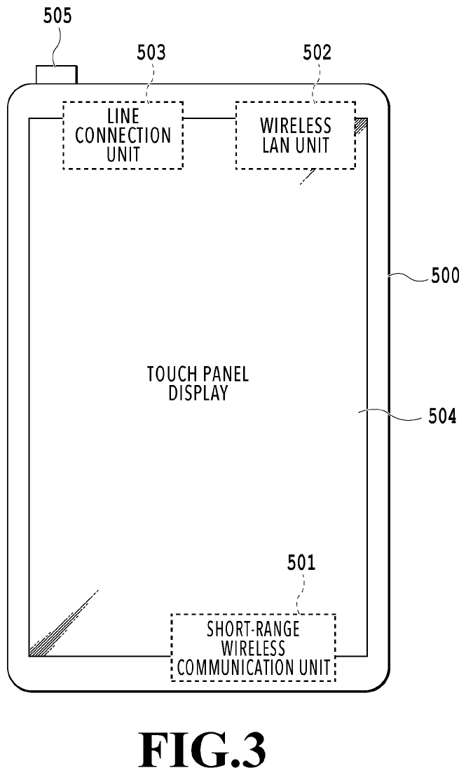

FIG. 3 is an exterior view of the smartphone 500 as an example of the device 400. The smartphone is a multifunction type mobile phone that has functions of a camera, an internet browser, an e-mail, and the like in addition to the function of the mobile phone. A short-range wireless communication unit 501 is a unit that establishes short-range wireless communication and communicates with a short-range wireless communication unit of a communication partner within a predetermined distance. A wireless LAN unit 502 is a unit that is connected with the local area network 102 (see FIG. 1) to establish communication by using the wireless LAN and is arranged within the device. A line connection unit 503 is a unit that is connected to a mobile phone line to establish communication and is arranged within the device. A touch panel display 504 includes both the LCD type display mechanism and touch panel type operation mechanism and is provided on a front surface of the smartphone 500. A typical operation method is to display an operation part in the form of a button on the touch panel display 504 to allow a user to perform a touch operation on the touch panel display 504 such that an event of the pressed button is issued. A power supply button 505 is used to turn on and off the power supply of the smartphone.

### (Printer)

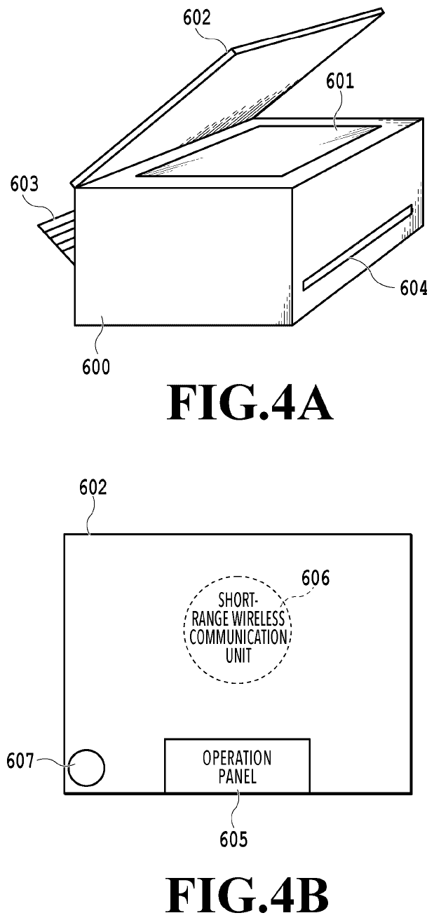

FIG. 4 is a diagram illustrating the printer 600 that is an example of the device 400, likewise. In the present embodiment, a multifunction printer (MFP) that is a printer having functions of also a scanner and others is applied as an example. FIG. 4A is a perspective view schematically illustrating an overall appearance of the printer 600. Platen glass 601 is a glassy transparent platform, which is used in a case of putting a document to read by a scanner. A platen glass pressure plate 602 is a cover that presses the document onto the platen glass to be fixed in a case of the reading by the scanner and prevents outside light from entering a scanner unit. A printing paper insertion slot 603 is an insertion slot to set various sizes of paper. The paper set in the printing paper insertion slot 603 is conveyed to a printing unit one by one and discharged from a printing paper discharge slot 604 after desired printing is performed.

FIG. 4B is a diagram schematically illustrating exterior of a top surface of the printer 600. An operation panel 605 and a short-range wireless communication unit 606 are provided on a top portion of the platen glass pressure plate 602. The short-range wireless communication unit 606 is a unit to establish the short-range wireless communication and communicates with a short-range wireless communication unit of a communication partner within a predetermined distance. As a wireless LAN antenna 607, an antenna that is connected with the local area network 102 to establish communication by using the wireless LAN is embedded.

### (Processing Configuration of Smartphone)

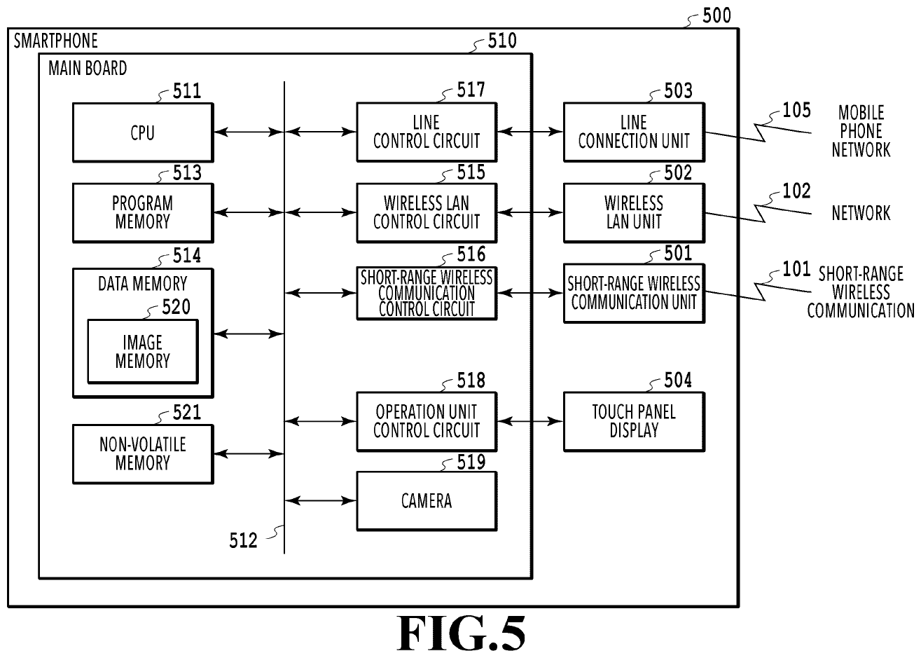

FIG. 5 is a block diagram illustrating a configuration of the smartphone 500 illustrated in FIG. 3. The smartphone 500 includes a main board 510 that controls overall the device, the short-range wireless communication unit 501, the wireless LAN unit 502, and the line connection unit 503.

On the main board 510, a CPU 511, a program memory 513, a data memory 514, a wireless LAN control circuit 515, a short-range wireless communication control circuit 516, and a line control circuit 517 are arranged. Additionally, on the main board 510, an operation unit control circuit 518, a camera 519, and a non-volatile memory 521 are arranged. The CPU 511 in the form of a microprocessor operates according to a control program stored in the program memory 513 in the form of a ROM that is connected via an internal bus 512 and contents of the data memory 514 in the form of a RAM.

The CPU 511 establishes wireless LAN communication with another communication terminal device by controlling the wireless LAN unit 502 via the wireless LAN control circuit 515. The CPU 511 can detect connection with another short-range wireless communication terminal and can transmit and receive data to and from the other short-range wireless communication terminal by controlling the short-range wireless communication unit 501 via the short-range wireless communication control circuit 516. Additionally, the CPU 511 is connected to the mobile phone network 105 and can make a call and transmit and receive data by controlling the line connection unit 503 via the line control circuit 517. The CPU 511 can perform desired display on the touch panel display 504 and receive an operation from the user by controlling the operation unit control circuit 518.

The CPU 511 captures an image by controlling the camera 519 and stores the captured image in an image memory 520 in the data memory 514. Additionally, in addition to the captured image, it is also possible to store an image obtained from the outside through the mobile phone line, the local area network 102, and the short-range wireless communication 101 into the image memory 520, or alternatively, it is also possible to transmit the image to the outside.

The non-volatile memory 521 is formed of a flash memory or the like and stores data that is desired to be saved also after the power supply is turned off. For example, in addition to address book data, various types of communication connection information, information of a device connected in the past, and so on, image data desired to be saved, application software implementing various functions on the smartphone 500, or the like is stored.

### (Processing Configuration of Printer)

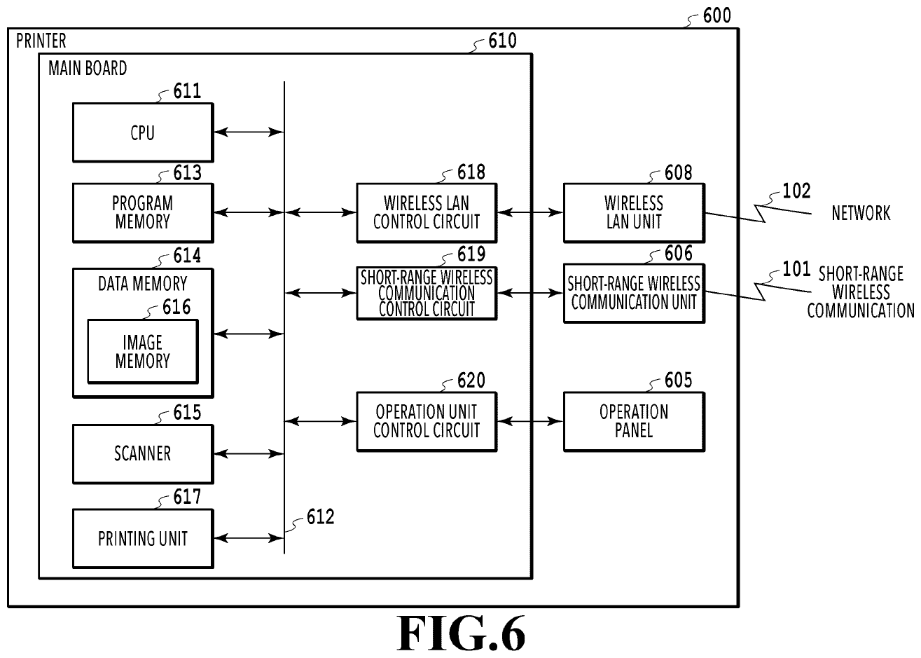

FIG. 6 is a block diagram illustrating a configuration of the printer 600 illustrated in FIG. 4A. The printer 600 includes a main board 610 that controls overall the device, a 608, and the short-range wireless communication unit 606. On the main board 610, a CPU 611, a program memory 613, a data memory 614, a scanner 615, a printing unit 617, a wireless LAN control circuit 618, a short-range wireless communication control circuit 619, and an operation unit control circuit 620 are arranged. The CPU 611 in the form of a microprocessor operates based on a control program stored in the program memory 613 in the form of a ROM connected via an internal bus 612 and data in the data memory 614 in the form of a RAM.

The CPU 611 reads the document by controlling the scanner 615 and stores the document in an image memory 616 in the data memory 614. Additionally, the CPU 611 can print an image in the image memory 616 in the data memory 614 on the printing medium by controlling the printing unit 617. The CPU 611 establishes wireless LAN communication with another communication terminal device by controlling the wireless LAN unit 608 through a wireless LAN communication control unit 618.

Additionally, the CPU 611 can detect connection with another short-range wireless communication terminal and can transmit and receive data to and from another short-range wireless communication terminal by controlling the short-range wireless communication unit 606 via the short-range wireless communication control circuit 619.

The CPU 611 can display a state of the printer 600 and display a function selection menu on the operation panel 605 and can receive an operation from the user by controlling the operation unit control circuit 620. The operation panel 605 includes a backlight, and the CPU 611 can control turning on and off the backlight via an operation unit control circuit 621. In a case where the backlight of the operation panel 605 is turned off, although it is difficult to see the display on the operation panel 605, it is possible to suppress power consumption of the printer 600.

### (Software Configuration)

FIG. 7 is a block diagram illustrating a software configuration of the processing system 100 described above in FIG. 1. In FIG. 7, only a software configuration related to processing of learning and inference in the present embodiment is illustrated, and the other software modules are not illustrated. For example, illustration of an operating system operating on each device and a server, various types of middleware, an application for maintenance, and the like is omitted.

The cloud server 200 includes a data-for-learning generation unit 250, the learning unit 251, and a learning model 252. The data-for-learning generation unit 250 is a module that generates data-for-learning that can be processed by the learning unit 251 from data received from the outside. The data-for-learning is a pair of input data X of the learning unit 251 and training data T indicating a correct answer of a result of the learning. The learning unit 251 is a program module that executes learning of the data-for-learning received from the data-for-learning generation unit 250 for the learning model 252. The learning model 252 accumulates learning results performed by the learning unit 251. Here, an example in which the learning model 252 is implemented as a neural network is described. It is possible to classify input data and determine an evaluation value by optimizing a weighting parameter between nodes of the neural network. The accumulated learning model 252 is distributed as the learned model to the edge server 300 and is used for the inference processing in the edge server 300.

The edge server 300 includes a data collection and provision unit 350, an inference unit 351, and a learned model 352. The data collection and provision unit 350 is a module that transmits the data received from the device 400 and the data collected by the edge server 300 itself as a data group used for the learning to the cloud server 200. The inference unit 351 is a program module that executes inference by using the learned model 352 based on the data transmitted from the device 400 and returns a result thereof to the device 400. Input data of the inference unit 351 is the data transmitted from the device 400. The learned model 352 is used for inference performed by the edge server 300. As with the learning model 252, the learned model 352 is also implemented as a neural network. As described later, the learned model 352 may be the same as the learning model 252 or may be a part of the learning model 252 extracted to be used. The learned model 352 is the learning model 252 that is accumulated in the cloud server 200 and then transmitted and stored. The learned model 352 may be the entire learning model 252 transmitted or only a part of the learning model 252 that is necessary for the inference by the edge server 300 and is extracted and transmitted.

The device 400 includes an application unit 450 and a data transmission and reception unit 451. The application unit 450 is a module implementing various functions executed by the device 400 and is a module using a system of learning and inference by the machine learning. The data transmission and reception unit 451 is a module that requests the edge server 300 to perform the learning or the inference. In a case of the learning, data used for the learning is transmitted by an instruction of the application unit 450 to the data collection and provision unit 350 of the edge server 300. Additionally, in a case of the inference, data used for the inference is transmitted by an instruction of the application unit 450 to the edge server 300, and a result thereof is received and then returned to the application unit 450.

Note that, although a mode in which the learning model 252 learned by the cloud server 200 is transmitted to the edge server 300 as the learned model 352 and used for the inference is described in the present embodiment, it is not limited to this mode. A configuration to execute each of the learning and the inference on the cloud server 200, the edge server 300, or the device 400 can be determined according to an allocation of hardware resources, a calculation amount, and a data communication amount. Alternatively, the device that executes the learning and the inference may be changed dynamically according to increase and decrease of the allocation of hardware resources, the calculation amount, and the data communication amount. In a case where the learning and the inference are performed by different subjects, for the inference side, it is possible to reduce logics used in only the inference and a capacity of the learned model 352 and allow for the execution at a higher speed.

### (Learning Model)

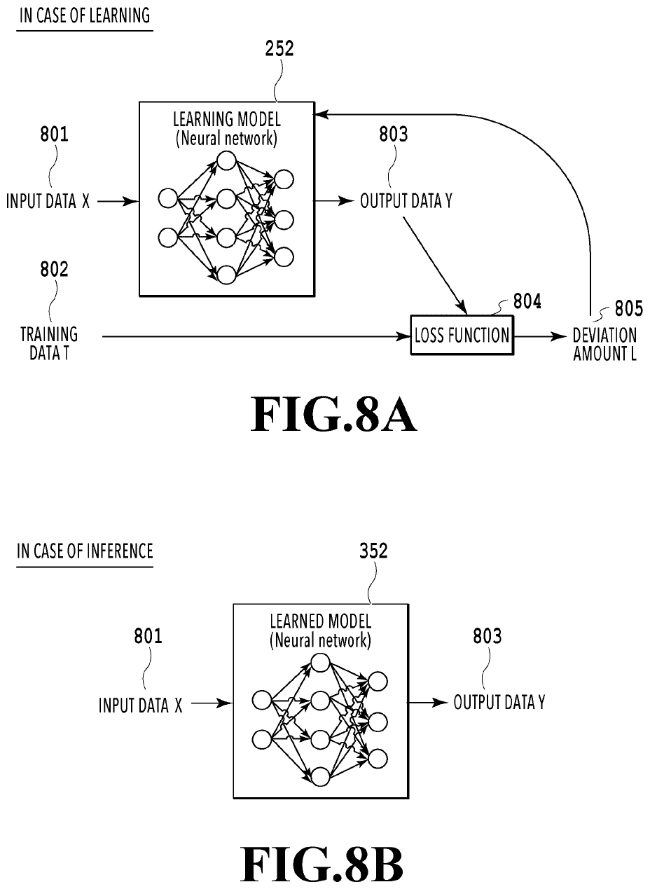

FIGS. 8A and 8B are a conceptual view illustrating a structure of inputting and outputting in a case of using the learning model 252 and the learned model 352.

FIG. 8A illustrates a relationship between the learning model 252 and input and output data thereof in a case of the learning.

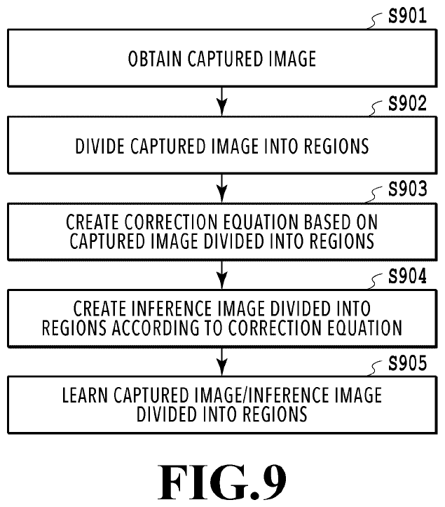

The input data X (801) is data inputted to an input layer of the learning model 252. Details of the input data X in the present embodiment are described later in FIG. 9 and the like. As a result of recognizing the input data X (801) by using the learning model 252 that is a machine learning model, output data Y (803) is outputted. In a case of the learning, as correct data of a recognition result of the input data X, training data T (802), which is described later in FIG. 9 and the like likewise, is provided. In addition, a deviation amount L (805) from the correct answer of the recognition result is obtained by providing the output data Y (803) and the training data T (802) to a loss function 804. Thus, a connection weighting coefficient and the like between the nodes of the neural network in the learning model 252 are updated to reduce the deviation amount L with respect to the many pieces of data-for-learning formed of the input data and the training data. In the present embodiment, the connection weighting coefficient and the like between the nodes of each neural network are adjusted to reduce the above-described error by using backpropagation.

A specific algorithm of this machine learning is not limited to the backpropagation. For example, it is also possible to use a nearest neighbor algorithm, a Naive Bayes method, a decision tree, a support vector machine, and so on. Additionally, it is also possible to use the deep learning in which the neural network is used, and the feature amount and the connection weighting coefficient for the learning are generated by itself.

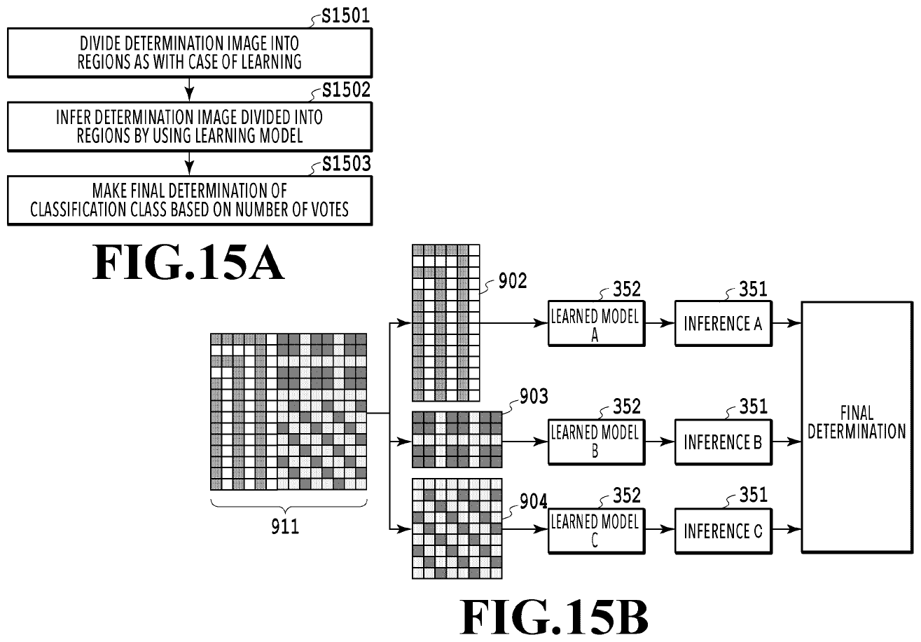

FIG. 8B illustrates a relationship between the learned model 352 and input and output data thereof in a case of the inference. The input data X (801) is data of an input layer of the learned model 352. Details of the input data X (801) in the present embodiment are described later in FIGS. 15A and 15B and the like. As a result of recognizing the input data X (801) by using the learning model 352 that is a machine learning model, the output data Y (803) is outputted. In a case of the inference, this output data Y (803) is used as an inference result. Note that, although it is described that the learned model 352 in a case of the inference includes the neural network similar to that of the learning model 252 in a case of the learning, it is also possible to prepare a learned model obtained by extracting only a part that is necessary for the inference as the learned model 352. Therefore, it is possible to reduce the data amount of the learned model 352 and reduce the neural network processing time in a case of the inference.

Embodiments of the present disclosure based on the configuration described above are described.

### FIRST EMBODIMENT

### (Learning Processing)

FIG. 9 is a flowchart illustrating learning processing according to a first embodiment of the present disclosure. This processing is executed by the learning unit 251 of the cloud server 200. In response to input of a start instruction of the substrate inspection by the user to the information processing apparatus, the processing in FIG. 9 is started. In FIG. 9, steps S901 to S904 indicate processing of generating an inference image as the training data based on the captured image, and a step S905 indicates a learning phase using the generated inference image as the training data. Note that, a sign “S” in description of each processing indicates that it is a step in the flowchart (hereinafter, the same applies to the flowchart in the present specification).

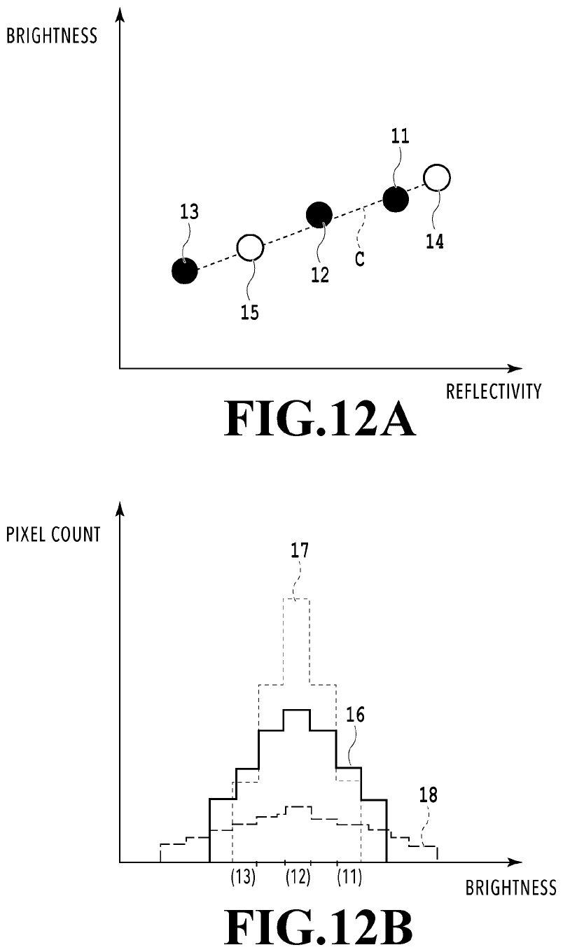

First, in S901, a captured image 901 is obtained. The captured image 901 is an image of an inspection region of a substrate as an inspection target that is captured by the digital camera 402 in the device 400 with infrared light. Note that, although the captured image is obtained by using the digital camera 402 in the present embodiment, an infrared camera or the like may be used. The captured image is obtained as binary data of each pixel forming the captured image. As described later, this obtainment of the captured image is performed by five times of image capturing at different brightnesses to obtain five levels of brightness (see FIG. 12B). Specifically, the different brightnesses are obtained by changing illuminance (an equation (1) described below) on the inspection region of the substrate and capturing an image of the inspection region.

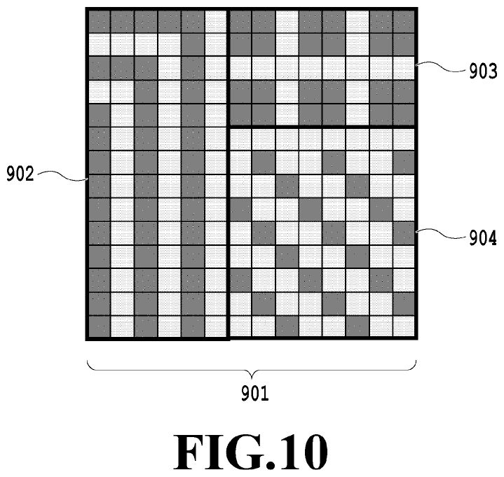

In this case, in the present embodiment, the substrate as the inspection target forms a printing head of the printer. That is, the processing system 100 of the present embodiment executes the inspection of the substrate in a manufacturing step of the printing head. In this inspection region, for example, there are a wiring, a bonded portion, and the like on the substrate, and because of a portion including them, the brightness and the contrast in the captured image are often not uniform in the entire inspection region. To deal with this, in the embodiment of the present disclosure, as described later in FIG. 10 and the like, the inspection region is divided into multiple regions, and the brightness and the contrast are obtained for each of the divided regions. In addition, the brightness and the contrast are corrected for each of the divided regions of the captured image to create a secondary image (hereinafter, also referred to as the inference image) of the original captured image, and this secondary image is used as the training image for the machine learning.

Note that, as a matter of course, the feature amount that is an element expressing the captured image and is additionally the target of the correction is not limited to the brightness and the contrast. For example, lightness, chroma, and the like may be used. Additionally, although the image is obtained by using infrared light in the present embodiment, the image may be captured by visible light.

FIG. 10 is a diagram illustrating the captured image obtained in S901. The captured image 901 obtained by capturing the inspection region on the substrate includes a region 902, a region 903, and a region 904 as an example. In addition, each of these regions may have different thickness, refractive index, surface roughness, and the like depending on whether there is the wiring and the bonded portion, and the brightness and the contrast may be different accordingly. For example, in some cases, the contrast and the brightness expressed by the region 902 are lower than the contrast and the brightness expressed by the region 903.

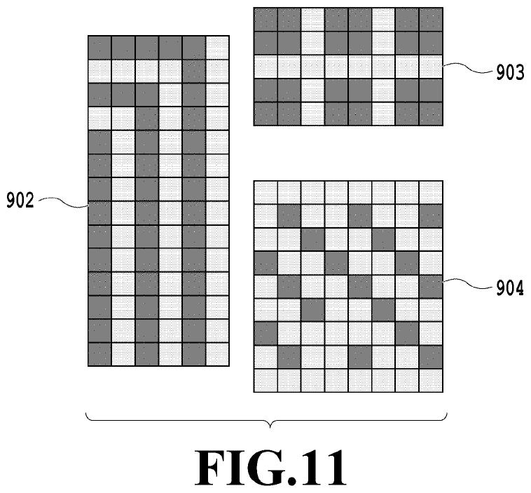

Next, in S902, the image is divided for each region. FIG. 11 illustrates this divided captured image, and the captured image 901 are divided into the region 902, the region 903, and the region 904. This division can be determined in advance depending on a difference in a substrate constituent pattern such as a circuit unit and a wiring unit in the inspection region of the substrate, for example. Here, in a case where the captured image is not divided, the brightness and the contrast are changed (corrected) uniformly among the regions in a case of generating the training image by changing (correcting) the brightness and the contrast based on the captured image, and there is a possibility that the training image with a biased tendency is generated. Therefore, in the present embodiment, the training image is generated by dividing the captured image such that the tendency such as the brightness can be reproduced easily for each divided region and then correcting each divided region. Note that, the division of the region may be division according to a boundary between the patterns as described above, or the region to be divided may be determined from a color tone around the boundary.

Next, in S903, a correction equation is created based on each image divided for each region. That is, based on the captured images of the divided region 902, the divided region 903, and the divided region 904, the correction equation is created for each divided region. In addition, in S904, the corresponding inference image is created according to the created correction equation of each divided region, and the inference image is used as the training image. For the sake of simplifying the descriptions, the correction equation creation and the correction of the brightness and the contrast based on the correction equation that are related to the divided region 902 illustrated in FIG. 11 are described below.

### <Correction Equation Creation of Brightness>

First, the correction equation creation of the brightness is described. Brightness L of the image can be expressed by the following equation (1) by using illuminance W and reflectivity R.

$$L = R / π W \qquad ( 1 )$$

Here, the reflectivity R of a single film can be expressed by the following equation (2) by using the refractive index N.

$$R = ( ( 1 - N ) / ( 1 + N ) ) \hat{} 2 \qquad ( 2 )$$

Based on the brightness L of the divided region 902 that is obtained according to the above-described equations (1) and (2), a correction equation C illustrated in FIG. 12A is created. Specifically, it is as follows.

Regarding the divided region 902 of the captured image, the brightness L of each pixel forming the divided region 902 is obtained, and a histogram thereof is obtained. FIG. 12B illustrates this histogram, which is expressed as a histogram 16. That is, the histogram 16 indicates that the brightnesses L obtained from the divided region 902 are distributed with five levels of values, and a pixel count of each brightness indicates any one of three levels of pixel counts as illustrated in FIG. 12B.

Next, out of the brightnesses L of the values of the five levels obtained as described above, in FIG. 12B, the reflectivity R obtained in advance according to the equation (2) with the refractive index N of the region corresponds to three brightnesses L indicated by (11), (12), and (13). This correspondence relationship is expressed as points of black circles 11, 12, and 13 in FIG. 12A. That is, the points of the black circles 11, 12, and 13 have the brightnesses (11), (12), and (13) in FIG. 12B, respectively. The correction equation C indicated by a broken line is obtained by obtaining a primary correlation between these points of the three black circles (S903). Note that, although the correlation equation is obtained by using the three brightnesses in the present embodiment, the number is not limited thereto. In order to enhance the correction accuracy, four or more brightnesses may be used to obtain the correlation equation. In this case, the correlation equation may be a secondary or higher correlation. Additionally, in a case where the surface roughness of the substrate is taken into consideration since the reflectivity depends on the surface roughness, it is desirable for the correlation equation to be secondary or higher.

### (Correction of Brightness)

Next, the brightness is corrected (changed) by using the correction equation C obtained as described above, and the inference image is created (S904). Specifically, the inference image having brightnesses of white circles 14 and 15 positioned on a straight line indicating the correction equation C in FIG. 12A is created. The inference image created as described above is used as the training image in the machine learning in the subsequent S905. Note that, although the number of the inference images created is two in the example illustrated in FIG. 12A, this is for the sake of simplifying the illustrations and descriptions, and as a matter of course, the number of the inference images created is not limited thereto.

Note that, in this case, it is preferable to create the inference image in which the brightness is determined taking into consideration an assumed variation of the reflectivity R. For example, in FIG. 12A, it is preferable to create multiple inference images in which the brightness is determined in correspondence with the maximum reflectivity and the minimum reflectivity. Additionally, the reflectivity R may be created by fixing two of the thickness, the refractive index, and the surface roughness and varying the one main item. For example, in a case where the surface roughness is the main cause of the variation of the brightness and the like, it is preferable to obtain the correction equation from the captured image in which the surface roughness is varied. Additionally, although one item is varied in the present embodiment, it is also possible to create a variety of images by creating the inference image by varying two or more items. Moreover, the brightness may be determined with the reflectivity that exceeds an assumed range. This makes it possible to create the inference image corresponding to a wider variation of the brightness.

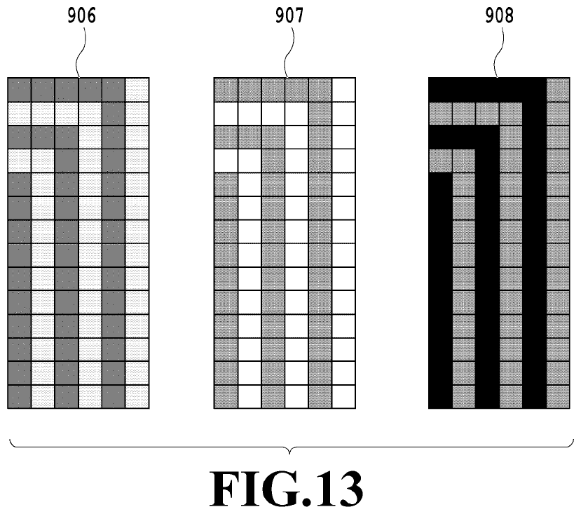

FIG. 13 is a diagram describing the inference image created as described above. In FIG. 13, with the above-described brightness correction (changing) processing, a captured image 906 of the divided region 902 becomes an inference image 907 (the white circle 14 in FIG. 12A) in which the brightness is increased and an inference image 908 (the white circle 15 in FIG. 12A) in which the brightness is reduced.

### (Correction of Contrast)

The correction (changing) of the contrast is performed on the histogram 16 of the brightness illustrated in FIG. 12B. A method of correction (changing) includes expansion or flattening of the distribution. In the present embodiment, flattening processing is performed. Specifically, the flattening is performed by narrowing or widening a range of the brightness while maintaining an area (a total pixel count) of the histogram 16. Histograms 17 and 18 of the brightness indicate correction results from this flattening. In the histogram 17 of the correction result illustrated in FIG. 12B, the range of the brightness is narrowed, and the pixel count for each brightness of the narrowed brightness range is increased; that is, the contrast is increased. On the other hand, in the histogram 18 of the correction result, the range of the brightness is widened, and the pixel count for each brightness of the widened brightness range is reduced; that is, the contrast is reduced.

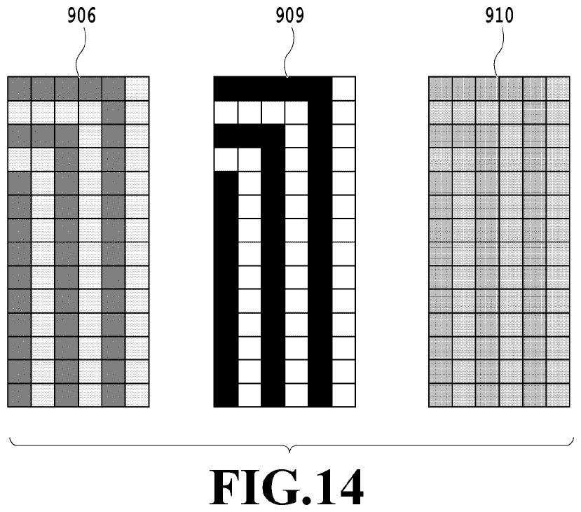

FIG. 14 is a diagram illustrating an example of the correction (changing) result of the contrast related to the divided region 902. As illustrated in FIG. 14, with the correction, the original image 906 (the histogram 16 in FIG. 12B) of the divided region 902 becomes an inference image 909 (the histogram 17 in FIG. 12B) in which the contrast is increased or an inference image 910 (the histogram 18 in FIG. 12B) in which the contrast is reduced.

Note that, shading correction may be performed to suppress brightness unevenness in the captured image. It is desirable to perform this shading correction before the creation of the correction equation in S903.

The descriptions above of the creation of the correction equation and the correction using the correction equation are about the divided region 902 illustrated in FIG. 11; however, it is apparent from the above-described descriptions that the same applies to the other divided regions 903 and 904, and accordingly, the descriptions about the other divided regions are omitted.

The inference image for each divided region described above is stored in a predetermined memory as data of one training image based on the brightness and the contrast (S904). Therefore, it is possible to obtain a greater number of the inference images (training images) based on a relatively small number of the captured images (original images).

Again, with reference to FIG. 9, in a case where the inference image is created as described above, in the subsequent S905, the machine learning using the multiple inference images of each divided region as the training image is performed. In this case, as illustrated in FIG. 8A, the captured image of the inspection region is the input data X (801). This captured image of the inspection region is also divided into the three regions 902, 903, and 904 as with the case of creating the above-described inference image, and the learning described above in FIG. 8A is performed for each of these divided regions. That is, the learning is performed for each region corresponding to the captured image (the input data X: 801) and the inference image (the training data T: 802) divided into regions, and the learning model 252 is generated.

Note that, although the inference image is created by correcting the binary data in the present embodiment, in a case of the image captured with visible light, the inference image may be created by correcting an RGB value. In this case, the inference image is created by determining a color tone range of each pattern from a processing range.

### (Inference Processing)

FIGS. 15A and 15B are diagrams describing the inference processing of the first embodiment of the present disclosure, which is processing executed by the inference unit 351 and the learned model 352 of the edge server 300. FIG. 15A illustrates a flowchart of the inference processing, and FIG. 15B illustrates a concept of the processing.

First, as with the case of obtaining the above-described captured image, a determination image 911 is obtained, and the determination image 911 is divided into regions (S1501). With this, the determination image 911 of the inspection region on the substrate is divided into the three divided regions 902, 903, and 904. Next, the inference (351: inference A, inference B, inference C) is performed by the learned model 352 (learned models A, B, and C) of each region (S1502).

Thereafter, final determination of a classification class is made based on the number of votes by the learned model 352 of each region (S1503). Specifically, it is as follows.

In the present embodiment, two types of classification determination are performed by the learned models 352 (the learned models A, B, and C) of the three divided regions. That is, determination indicating that a defect of the substrate cannot be allowed in the inspection is E classification determination, for example, and determination indicating that the defect can be allowed, which includes a case with no defect, is F classification determination. In addition, in a case where there is the E classification determination in at least one of the inference units 351 (the inference A, the inference B, and the inference C) related to the three divided regions, respectively, it is determined as the E classification determination, that is, bad determination indicating that there is a defect in the inspection of the substrate. In a case where all the inference units 351 (the inference A, the inference B, and the inference C) related to the three divided regions, respectively, are determined as the F classification determination, it is determined as good determination.

As described above, according to the first embodiment of the present disclosure, it is possible to secondarily create a greater number of the training images by a relatively small amount of the captured images, and it is possible to enhance the expression accuracy of the training image.

### Second Embodiment

A second embodiment of the present disclosure is described. Note that, a different portion from the first embodiment is mainly described.

### (Learning Processing)

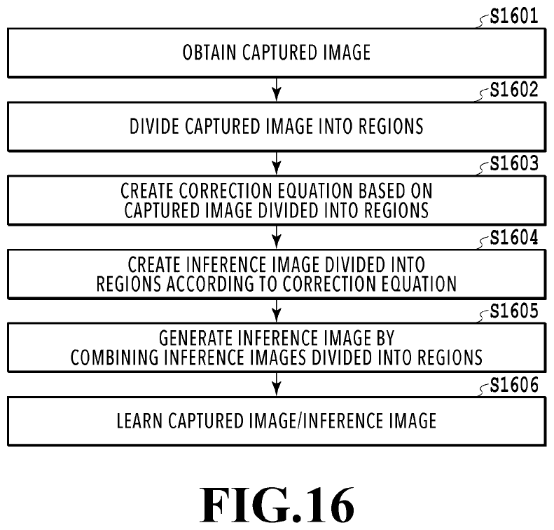

FIG. 16 is a flowchart illustrating learning processing according to the second embodiment. In the first embodiment, the learning model 252 is created for each region from the captured image 901 and the inference image divided into regions; however, in the second embodiment, after the inference image divided into regions is created, an inference image 905 is created by connecting the divided images (S1605).

Specifically, first, the captured image 901 (see FIG. 10) is obtained (S1601), and the captured image 901 is divided into regions (S1602). With this division, the captured image 901 is divided into the region 902, the region 903, and the region 904. In addition, the correction equation is created (S1603), and according to the correction equation, the inference image of each divided region is created (S1604).

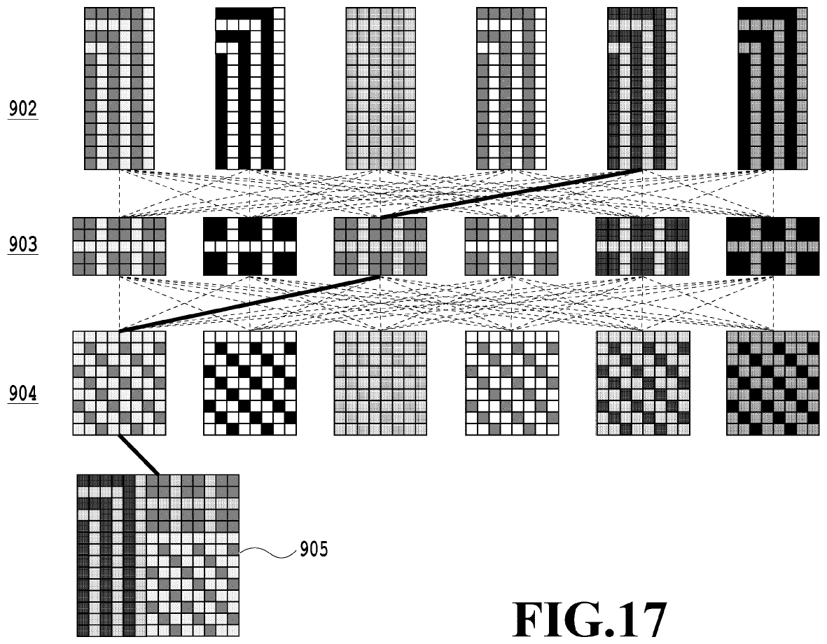

Thereafter, the inference image is generated by combining the inference images of the corresponding divided regions (S1605). FIG. 17 is a diagram describing this combining. In FIG. 17, the inference images connected with each other by a thick solid line and a broken line indicate the combination of the inference images of the corresponding divided regions. Thus, in the present embodiment, the inference images of the corresponding divided regions are combined with each other, and the inference image that is obtained as this combination (including a combination of only either of the brightness and the contrast) is generated. In FIG. 17, the combination connected by the thick solid line is a combination generating the inference image 905 illustrated in FIG. 17.

According to the second embodiment described above, it is possible to generate a further greater number of the inference images (the training images) than that of the first embodiment.

### (Inference Processing)

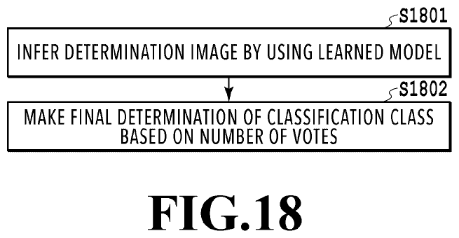

FIG. 18 is a flowchart illustrating the inference processing according to the second embodiment of the present disclosure. In the first embodiment, the determination image 911 is inferred by the learned model for each divided region; however, in the second embodiment, the inference is performed without dividing the determination image 911 into regions.

Specifically, first, one determination image is inferred by the learned model (S1801). In addition, final determination of the classification class is made based on the number of votes by the learned model (S1802).

With this configuration, it is possible to reduce the learning models and to improve the efficiency of the learning and the inference.

### Third Embodiment

A third embodiment of the present disclosure is described. Note that, a different portion from the first embodiment is mainly described.

### (Image Generation Method)

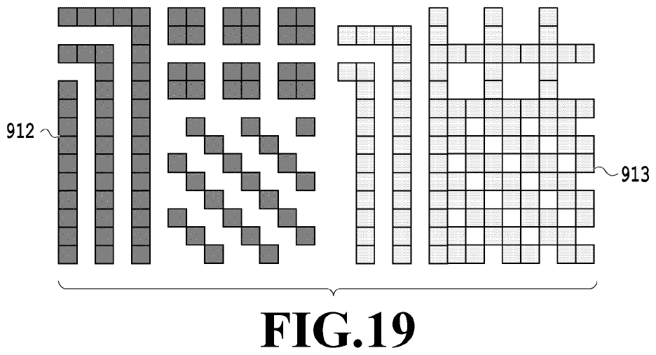

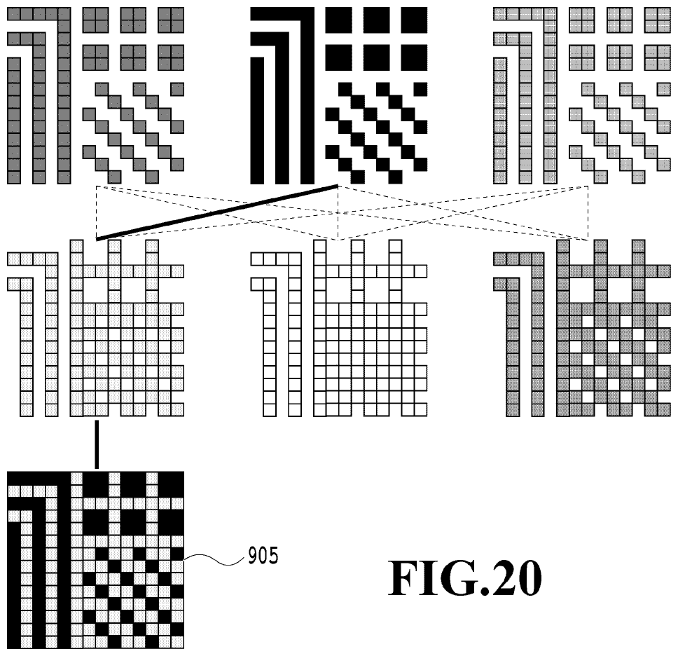

FIG. 19 is a diagram illustrating the region division according to the third embodiment of the present disclosure. In the first embodiment, the regions are divided according to each pattern; however, as illustrated in FIG. 19, the regions may be divided as an image 912 of only the pattern and an image 913 of only a background. As illustrated in FIG. 20, in the divided image, after the inference image divided into regions is created as with the second embodiment, the regions are combined again to create the inference image. Thereafter, the learning model is created by using the captured image and the inference image (the training image). In addition, as with the first embodiment, the learning model may be created while the regions are divided.

Note that, the learning model may be created by combining the first to third embodiments. For example, it is also possible to create the inference image 905 from the image divided into regions in each of the background and the pattern of each region.

With this configuration, it is possible to reduce the learning models and to create the information processing system having high determination accuracy.

### OTHER EMBODIMENTS

The present disclosure can be implemented also by processing in which a program implementing one or more functions of the above-described embodiments is supplied to a system or an apparatus via a network or a storage medium, and a computer of the system or the apparatus reads out and executes the program. The computer may include one or more processors or circuits and may include a network of separated multiple computers or separated multiple processors or circuits to read out and execute a computer-executable command.

The processor or the circuit may include a central processing unit (CPU), a micro processing unit (MPU), a graphics processing unit (GPU), an application specific integrated circuit (ASIC), and a field-programmable gate array (FPGA). Additionally, the processor or the circuit may include a digital signal processor (DSP), a data flow processor (DFP), or a neural processing unit (NPU).

The present disclosure is favorable for semiconductor processing, particularly, a printing element substrate for liquid ejection. It is expected in processing of the printing element substrate that, since multiple films are laminated while multiple substrates are overlapped with each other, behaviors of the brightness and the contrast of the regions and the patterns are entangled complicatedly, and the amount of the learning data to create the learning model is enormous. To deal with this, with the embodiments described above being applied, it is possible to create the information processing system having high determination accuracy with a small number of images.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-198154, filed Nov. 22, 2023, which is hereby incorporated by reference wherein in its entirety.

What is claimed is:

1. An information processing system, comprising:
a division unit configured to divide a captured image;
a correction equation creation unit configured to create a correction equation for each divided region of the divided captured image based on a feature amount expressing an image of the divided region;
an inference image creation unit configured to create an inference image expressed by the feature amount for each divided region according to the correction equation for each divided region; and
a learning unit configured to execute machine learning on a learning model in which the inference image is used as training data, and the captured image is used as input data.

2. The information processing system according to claim 1, further comprising:
an inference unit configured to infer an inspection image obtained by image capturing by using the learning model on which the execution of the machine learning is done; and
a determination unit configured to determine the inspection image based on the inference by the inference unit.

3. The information processing system according to claim 1, wherein
the learning model outputs output data as a result of recognition of the input data by the machine learning.

4. The information processing system according to claim 1, wherein
the captured image is captured by using infrared light.

5. The information processing system according to claim 1, wherein
the correction equation is created from three or more captured images in which a thickness, a surface roughness, and a refractive index of a subject are varied.

6. The information processing system according to claim 1, wherein
the captured image is captured by using visible light.

7. The information processing system according to claim 1, wherein
the correction equation is created from image data obtained by RGB correction.

8. The information processing system according to claim 1, wherein
the correction equation is created from image data obtained by binarization correction.

9. The information processing system according to claim 7, wherein
the correction equation is calculated by primary correction.

10. The information processing system according to claim 7, wherein
the correction equation is calculated by polynomial approximation correction.

11. The information processing system according to claim 1, wherein
the division unit performs the division for each pattern of a subject.

12. The information processing system according to claim 1, wherein
the division unit performs the division into a pattern of a subject and a background.

13. The information processing system according to claim 1, wherein
the captured image is an image for inspection of semiconductor processing or for inspection of a printing element substrate that can eject a liquid.

14. An information processing apparatus, comprising:
an input reception unit configured to receive input of a captured image;
a division unit configured to divide the captured image;
a correction equation creation unit configured to create a correction equation for each divided region of the divided captured image based on a feature amount expressing an image of the divided region;
an inference image creation unit configured to create an inference image expressed by the feature amount for each divided region according to the correction equation of each divided region; and
a learning unit configured to execute machine learning on a learning model in which the inference image is used as training data, and the captured image inputted by the input reception unit is used as input data.

15. A machine learning method, comprising:
dividing a captured image;
creating a correction equation for each divided region of the divided captured image based on a feature amount expressing an image of the divided region;
creating an inference image expressed by the feature amount for each divided region according to the correction equation for each divided region; and
executing machine learning on a learning model in which the inference image is used as training data, and the captured image is used as input data.
